(19) United States
(12) Patent Application Publication
(10) Pub. No.: US 2012/0300848 A1
(43) Pub. Date: Nov. 29, 2012

(54) APPARATUS AND METHOD FOR GENERATING AN INTER-PREDICTION FRAME, AND APPARATUS AND METHOD FOR INTERPOLATING A REFERENCE FRAME USED THEREIN

(75) Inventors: Sunyeon Kim, Seoul (KR); Jeongyeon Lim, Gyeonggi-do (KR); Gyumin Lee, Gyeonggi-do (KR); Jaehoon Choi, Gyeonggi-do (KR); Jechang Jeong, Seoul (KR); Kangjun Lee, Gyeonggi-do (KR)

(73) Assignee: SK TELECOM CO., LTD., Seoul (KR)

(21) Appl. No.: 13/513,091

(22) PCT Filed: Nov. 25, 2010
(86) PCT No.: PCT/KR10/08386

§ 371 Date: Aug. 10, 2012

(30) Foreign Application Priority Data
Dec. 1, 2009 (KR) 10-2009-0117873

(51) Int. Cl. H04N 7/32

(52) U.S. Cl. 375/240.16; 375/240.12; 375/E07.104; 375/E07.243

(57) ABSTRACT

The present disclosure provides an apparatus and a method for generating an inter-prediction frame, and an apparatus and a method for interpolating a reference frame used therein. The apparatus for interpolating the reference frame includes a directivity determiner for determining directivity of a quarter pixel located at the intersection of a left diagonal line and a right diagonal line of a half-pixel unit based on surrounding pixels of the quarter pixel; and an interpolation processor for interpolating a pixel value for the quarter pixel by differently applying a linear interpolation method depending on the directivity determined by the directivity determiner.

### TECHNICAL FIELD

The present disclosure relates to an apparatus and method for generating an inter-prediction frame, and an apparatus and method for interpolating a reference frame used therein. More particularly, the present disclosure relates to an apparatus and a method for generating an inter prediction frame, which can more exactly predict pixel values of quarter pixels located at intersections of left diagonal lines and right diagonal lines by unit of half pixels for a reference frame to be used for the prediction in comparison with the general H.264 standard by interpolating the pixel values of the pixels through a more exact method and thus improve the inter prediction efficiency, and an apparatus and a method for interpolating a reference frame used therein.

### BACKGROUND

The statements in this section merely provide background information related to the present disclosure and may not constitute prior art.

Following the development of information and communication technology including the Internet, communication is on the rise in the form of video as well as text and voice. Users unsatisfied with existing text-oriented communication services are being offered an increasing number of multimedia services encompassing texts, images, music, and various types of information. The enormous quantity inherent to multimedia data calls for larger and larger storage capacities and broader bandwidths. Therefore, compressive coding technologies have become the requisite in transmitting multimedia data including text, video, and audio.

The basic principle of compressing data is the process of eliminating redundant elements. Accordingly, the digital image data compression can be performed through methods divided broadly into a method of removing the spatial redundancy corresponding to the repetition of the same color or object in an image, a method of removing the temporal redundancy corresponding to the repetition of the same note in an audio data or a case where there is little change of an adjacent frame in a dynamic image frame, or a method of removing the redundancy of a frequency signal having high visual and perceptive abilities by using statistical characteristics of a generated code.

Particularly, as a dynamic image compressing method, H.264/AVC recently draws interest for its further improved compression efficiency over MPEG-4 (Moving Picture Experts Group-4).

The H.264 standard corresponds to a digital video codec standard having a very high data compression rate, and is also referred to as MPEG-4 part 10 or AVC (Advanced Video Coding). This standard is a result of the joint video team performing the standardization between VCEG (Video Coding Experts Group) of ITU-T (International Telecommunication Union Telecommunication Standardization Sector) and MPEG of ISO/IEC (International Standardization Organization/International Electrotechnical Commission).

The H.264 standard uses a motion estimation and compensation method as a representative method to reduce the temporal redundancy. The method of reducing the temporal redundancy is also referred to as a temporal prediction method, and corresponds to a scheme of performing a prediction with reference to a reference block 122 of another frame 120 temporally adjacent in predicting a current block 112 of a current frame 110, as shown in FIG. 1. That is, in inter-predicting the current block 112 of the current frame 110, the temporally adjacent reference frame 120 is searched for, and searching is performed for the reference block 122 which is most similar to the current block 112 within the reference frame 120. Here, the reference block 122 is a block, by which the current block 112 can be predicted best, and a block having the smallest SAD (Sum of Absolute Difference) between the block and the current block 112 can be the reference block 122. The reference block 122 becomes the reference of a predicted block for the current block 112, and a residual block is generated by subtracting the reference block 122 from the current block 112. The generated residual block is encoded and inserted in a bitstream. In this event, the relative difference between a position of the current block 112 in the current frame 110 and a position of the reference block 122 in the reference frame 120 is referred to as a motion vector 130 which is also encoded like the residual block. The temporal prediction is also referred to as an inter prediction or an inter frame prediction.

The motion estimation and compensation method is to search for the most similar portion to a particular portion of the current frame in a previous or a next reference frame and transmit only a difference component between two portions. The above method can more effectively reduce data because difference components to be transmitted are decreased as a motion vector is found as accurately as possible, but it requires a substantially long estimation time and large amount of operations in order to find the most similar portion in a previous or a next image. Accordingly, there are continued efforts to reduce the motion estimation time which takes the longest portion of time in encoding a video.

Meanwhile, the motion estimation method largely includes an estimation method on the pixel-by-pixel basis and another estimation method on the block-by-block basis which is more popular.

The estimation method on the block-by-block basis is to divide an image into regular sized blocks and finding a block most closely matched with the current block of the current frame within a searching area (reference frame) of the previous image, as described above. In this event, a motion vector indicating a difference between the reference block and the current block is encoded and processed. Various matching functions can be used in the matching calculation between the two blocks, and the most commonly used is SAD (Sum of Absolute Difference), which is value generated by adding all absolute values of differences of pixels between the two blocks.

Further, in the H.264 standard, a motion estimation is performed up to a 4×4 block unit, which corresponds to a smaller block size in comparison with a block size used in the conventional method, in order to improve the compression performance, and a motion compensation is performed down to a ¼ pixel unit. Based on such technologies, the H.264 video encoding standard has doubled the compression performance of the conventional MPEG-4 ASP (Advanced Simple Profile) video encoding standard.

FIG. 1 is a diagram for illustrating a method for interpolating a ¼ pixel used for a motion estimation in the H.264 standard. The H.264 standard defines an integer pixel, a half pixel (½ pixel), and a quarter pixel (¼ pixel) as shown in FIG. 1. For the purpose of description, only the necessary positions of respective pixels are illustrated in FIG. 1.

The integer pixel refers to a unit for expressing an original image, and includes pixels located in A, B, C, D, E, F, G, H, I, J, K, L, M, N, O, P, Q, R, S, T, U, etc. in FIG. 1. Further, the half pixel refers to a unit for expressing an image of the integer pixel down to a ½ pixel unit, and includes pixels located in aa, bb, b, cc, dd, h, j, ee, ff, gg, hh, ii, jj, etc., which correspond to ½ positions between respective integer pixels. In addition, the quarter pixel refers to a unit for expressing the image of the integer pixel up to a ¼ pixel unit, and includes a, c, d, e, f, g, kk, i, k, m, n, o, p, mm, nn, oo, etc., which correspond to ½ positions between respective integer pixels and half pixels and between respective half pixels.

A method of interpolating the ¼ pixel is implemented by generating the half pixels and the quarter pixels by using the integer pixels. More specifically, in order to generate half pixels located in positions of aa, bb, b, hh, ii, jj, cc, dd, h, ee, ff, and gg, each pixel value is first generated by applying a 6 tap Wiener filter (coefficients: 1, −5, 20, 20, −5, 1) in vertical and horizontal directions. For example, a pixel value of a half pixel located in a position of b between two integer pixels G and H can be obtained by applying the 6 tap Wiener filter to integer pixels E, F, G, H, I, and J in the horizontal direction, which is represented as defined in Equation 1.

b=(E−5F+20G+20H−5I+J)>>5 Equation 1

In order to generate a pixel value of a half pixel located in a position of j, the same 6 tap Wiener filter is applied to positions of aa, bb, b, hh, ii, and jj in the same manner.

Next, the pixel values of quarter pixels located in positions of a, c, i, and k are calculated by applying a linear interpolation method in the horizontal direction, and the pixel values of quarter pixels located in positions of d, f, m, and o are calculated by applying the linear interpolation method in the vertical direction. Here, the linear interpolation method is for the multiplication of coefficients depending on distances from an original signal.

Further, the pixel values of quarter pixels located in positions of e, g, n, and p are obtained by a linear interpolation method of half pixels in a diagonal direction through a method defined in Equation 2.

e=(b+h+1)>>1;left diagonal direction

g=(b+ee+1)>>1;right diagonal direction

n=(h+hh+1)>>1;right diagonal direction

p=(ee+hh+1)>>1;left diagonal direction Equation 2

As described above, in a method of calculating the pixel values of quarter pixels located in the left diagonal direction and the right diagonal direction such as the quarter pixels located in the positions e, g, n, and p, each pixel value can be obtained with a relatively small amount of operations because each pixel value is obtained by the linear interpolation method simply with reference to a pixel value located in a half pixel position in the diagonal direction. However, since thus obtained pixel values of the quarter pixels located in the left diagonal direction and the right diagonal direction contain many errors, the inter prediction efficiency is significantly deteriorated.

### DISCLOSURE

### Technical Problem

To solve the above-mentioned problems, an aspect of the present disclosure provides an apparatus and a method for generating an inter prediction frame as well as an apparatus and a method for interpolating a reference frame used in the same, which can more exactly predict pixel values of corresponding quarter pixels located at intersections of left diagonal lines and right diagonal lines by unit of half pixels for a reference frame to be used for the prediction in comparison with the general H.264 standard by interpolating the pixel values of the quarter pixels in a more accurate method and thus improve the inter prediction efficiency.

### SUMMARY

An embodiment of the present disclosure provides an apparatus for interpolating a reference frame by unit of quarter pixels, the apparatus including: a directivity determiner for determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point; and an interpolation processor for interpolating a pixel value for the quarter pixel by differently applying a linear interpolation method depending on the directivity determined by the directivity determiner.

The interpolating apparatus preferably includes: a horizontal direction calculator for calculating an absolute value of a difference between pixel values of pixels located in a left side and a right side of the quarter pixel; a vertical direction calculator for calculating an absolute value of a difference between pixel values of pixels located in an upper side and a lower side of the quarter pixel; a left diagonal direction calculator for calculating an absolute value of a difference between pixel values of pixels located at both ends of the left diagonal line of the quarter pixel; and a right diagonal direction calculator for calculating an absolute value of a difference between pixel values of pixels located at both ends of the right diagonal line of the quarter pixel. Here, the directivity determiner determines the directivity as a direction corresponding to a smallest absolute value among absolute values calculated by the horizontal direction calculator, the vertical direction calculator, the left diagonal direction calculator, and the right diagonal direction calculator.

When the directivity for the quarter pixel is determined as a horizontal direction by the directivity determiner, the interpolation processor may predict the pixel value for the quarter pixel according to the following equation.

e=(d+f+1)>>1

In the above equation, e is the quarter pixel, d is the pixel located in the left side of the quarter pixel, f is the pixel located in the right side of the quarter pixel, and >> is a shift operation considering a rounding off.

In addition, when the directivity for the quarter pixel is determined as a vertical direction by the directivity determiner, the interpolation processor may predict a pixel value for the quarter pixel according to the following equation.

e=(a+i+1)>>1

In the above equation, e is the quarter pixel, a is the pixel located in the upper side of the quarter pixel, i is the pixel located in the lower side of the quarter pixel, and >> is a shift operation considering a rounding off.

In addition, when the directivity for the quarter pixel is determined as a right diagonal direction by the directivity determiner, the interpolation processor may predict a pixel value for the quarter pixel according to the following equation.

e=(G+j+1)>>1

In the above equation, e is the quarter pixel, G is the pixel located in a left upper side of the quarter pixel, j is the pixel located in a right lower side of the quarter pixel, and >> is a shift operation considering a rounding off.

In addition, when the directivity for the quarter pixel is determined as a left diagonal direction by the directivity determiner, the interpolation processor may predict a pixel value for the quarter pixel according to the following equation.

e=(b+h+1)>>1

In the above equation, e is the quarter pixel, b is the pixel located in a right upper side of the quarter pixel, h is the pixel located in a left lower side of the quarter pixel, and >> is a shift operation considering a rounding off.

Another embodiment of the present disclosure provides an apparatus for generating an inter prediction frame, the apparatus includes: an interpolator for determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point and interpolating a reference frame by differently applying a linear interpolation method according to determined directivity; a motion estimator for estimating a motion of a current frame based on an interpolated reference frame and determining a motion vector; and a motion compensator for performing a motion compensation on the interpolated reference frame by using the motion vector determined by the motion estimator.

Yet another embodiment of the present disclosure provides a method for interpolating a reference frame by unit of quarter pixels, the method including: determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point; and interpolating a pixel value for the quarter pixel by differently applying a linear interpolation method according to the directivity determined in determining of the directivity.

Here, determining of the directivity preferably includes: calculating an absolute value of a difference between pixel values of pixels located in a left side and a right side of the quarter pixel, an absolute value of a difference between pixel values of pixels located in an upper side and a lower side of the quarter pixel, an absolute value of a difference between pixel values of pixels located at both ends of the left diagonal line of the quarter pixel, and an absolute value of a difference between pixel values of pixels located at both ends of the right diagonal line of the quarter pixel; and selecting a smallest absolute value by comparing between respective calculated absolute values. In this case, the directivity is determined as a direction corresponding to a selected absolute value.

Yet another embodiment of the present disclosure provides a method for generating an inter prediction frame, the method including: determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point; interpolating a reference frame by differently applying a linear interpolation method depending on the directivity determined in determining of the directivity; estimating a motion of a current frame based on an interpolated reference frame and determining a motion vector; and generating a predicted frame for the current frame by performing a motion compensation on the interpolated reference frame by using the motion vector determined in estimating of the motion.

### Advantageous Effects

According to embodiments of the present disclosure as described above, the inter prediction efficiency can be improved by interpolating pixel values of quarter pixels located at intersections of left diagonal lines and right diagonal lines by unit of half pixels for a reference frame to be used for the prediction in a more accurate way.

### DESCRIPTION OF DRAWINGS

FIG. 1 is a diagram for illustrating the relation between a quarter pixel and an integer pixel;

FIG. 2 is a diagram for schematically illustrating an inter prediction frame generating apparatus according to an embodiment of the present disclosure;

FIG. 3 is a flowchart for illustrating a reference frame interpolating method used in the inter prediction frame generating apparatus of FIG. 2; and

FIG. 4 is a flowchart for illustrating an inter prediction frame generating method by the inter prediction frame generating apparatus of FIG. 3.

### DETAILED DESCRIPTION

Hereinafter, embodiments of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

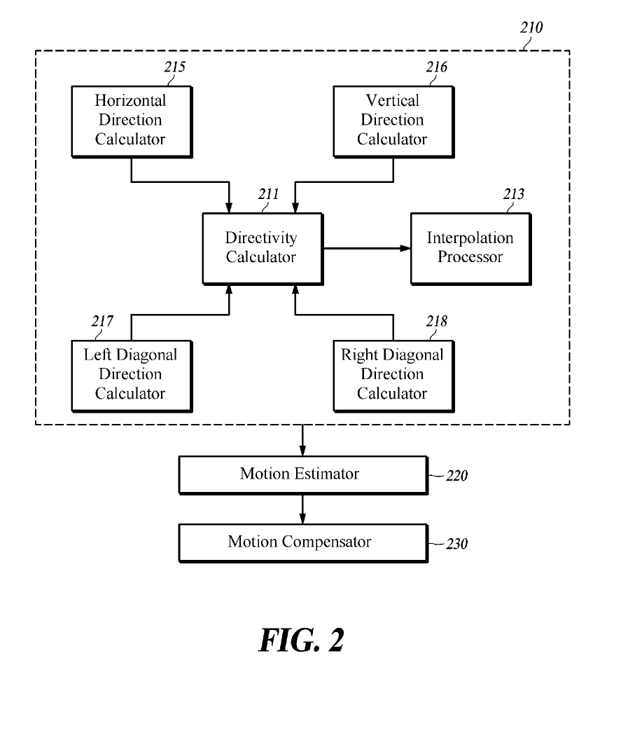

FIG. 2 is a diagram schematically illustrating an inter prediction frame generating apparatus according to an embodiment of the present disclosure.

Referring to FIG. 2, the inter prediction frame generating apparatus includes an interpolator 210, a motion estimator 220, and a motion compensator 230.

The interpolator 210 determines the directivity for a quarter pixel located at the intersection of a left diagonal line and a right diagonal line in the unit of half pixels based on pixels located in surroundings of the quarter pixel, and interpolates a reference frame by applying different linear interpolation methods according to the determined directivity. Here, the interpolator 210 may be implemented as one element within the inter prediction frame generating apparatus, and may include a directivity determiner 211, an interpolation processor 213, a horizontal direction calculator 215, a vertical direction calculator 216, a left diagonal direction calculator 217, and a right diagonal direction calculator 218 as shown in FIG. 2.

In this event, the directivity determiner 211 determines the directivity for the corresponding quarter pixel located in the intersection of the left diagonal line and the right diagonal line in the unit of half pixels based on the pixels located in surroundings of the quarter pixel.

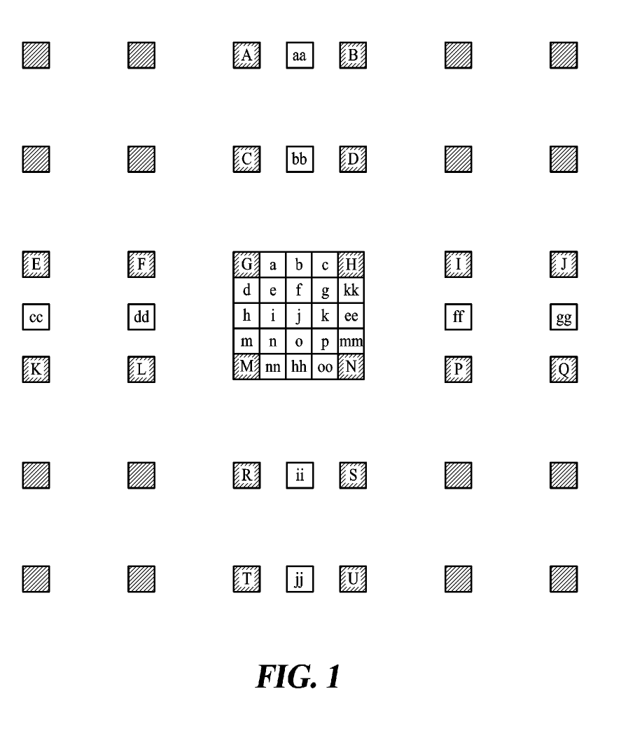

For example, for integer pixels G, H, M, and N shown in FIG. 1, half pixels are located in positions of b, h, j, ee, and hh. Further, quarter pixels a, c, d, e, f, g, kk, i, k, m, n, o, p, mm, nn, and oo are located between the inter pixels G, H, M, and N and the half pixels b, h, j, ee, and hh, respectively. Here, left diagonal lines in the unit of half pixels are formed by connecting pixels b, e, and h, pixels H, g, j, n, and M, and pixels ee, p, and hh. In addition, right diagonal lines in the unit of half pixels are formed by connecting pixels b, g, and ee, pixels G, e, j, p, and N, and pixels h, n, and hh. In this event, quarter pixels located at intersections of the left diagonal lines and the right diagonal lines in the unit of half pixels are e, g, n, and p. In a case of a quarter pixel e, the directivity determiner 211 determines the directivity for the quarter pixel e based on pixels G, a, b, d, f, h, i, and j located in surroundings of the quarter pixel e.

The interpolation processor 213 interpolates a pixel value for a corresponding quarter pixel by applying different linear interpolation methods according to the directivity determined by the directivity determiner 211.

Meanwhile, in order to determine the directivity for quarter pixels e, g, n, and p, the horizontal direction calculator 215 calculates an absolute value of a difference between pixel values of pixels located in left and right sides of a corresponding quarter pixel. For example, in a case of the quarter pixel e, pixels d and f are located in right and left sides of the pixel e, respectively, so that the horizontal direction calculator 215 calculates an absolute value of a difference between pixel values of the pixels d and f as defined in Equation 3.

Hor=|d−f| Equation 3

In Equation (3), Hor denotes a value calculated by the horizontal direction calculator 215, and corresponds to a calculated value for a horizontal direction.

Further, the vertical direction calculator 216 calculates an absolute value of a difference between pixel values of pixels located in upper and lower sides of a corresponding quarter pixel. For example, in a case of the quarter pixel e, pixels a and i are located in upper and lower sides of the pixel e, respectively, so that the vertical direction calculator 216 calculates an absolute value of a difference between pixel values of the pixels a and i as defined in Equation (4).

Ver=|a−i| Equation 4

In Equation (4), Ver denotes a value calculated by the vertical direction calculator 216, and corresponds to a calculated value for a vertical direction.

Moreover, the left diagonal direction calculator 217 calculates an absolute value of a difference between pixel values of pixels located in both ends of a left diagonal line of a corresponding quarter pixel. For example, in a case of the quarter pixel e, pixels b and h are located in both ends of the left diagonal line, so that the left diagonal direction calculator 217 calculates an absolute value of a difference between pixel values of the pixels b and h as defined in Equation 5.

Dig_left=|b−h| Equation 5

In Equation (5), Dig_left denotes a value calculated by the left diagonal direction calculator 217, and corresponds to a calculated value for a left diagonal direction.

Furthermore, the right diagonal direction calculator 218 calculates an absolute value of a difference between pixel values of pixels located in both ends of a right diagonal line of a corresponding quarter pixel. For example, in a case of the quarter pixel e, pixels G and j are located in both ends of the right diagonal line, so that the right diagonal direction calculator 218 calculates an absolute value of a difference between pixel values of the pixels G and j as defined in Equation 6.

Dig_right=|G−j| Equation 6

In Equation (6), Dig_right denotes a value calculated by the right diagonal direction calculator 218, and corresponds to a calculated value for a right diagonal direction.

In this event, the directivity determiner 211 selects a calculated value having the smallest absolute value from respective absolute values determined by the horizontal direction calculator 215, the vertical direction calculator 216, the left diagonal direction calculator 217, and the right diagonal direction calculator 218, and then determines the directivity of the corresponding quarter pixel as a direction corresponding to the selected absolute value. The reason to select the calculated value having the smallest absolute value is that a smaller absolute value of a difference between pixels located in surroundings of a quarter pixel means a higher correlation with the corresponding quarter pixel. Here, although the quarter pixel e has been described as an example, such a method can be equally applied to quarter pixels g, n, and p.

The interpolation processor 213 interpolates the corresponding quarter pixel by applying a linear interpolation method corresponding to the directivity of the corresponding quarter pixel determined by the directivity determiner 211. For example, in a case of the quarter pixel e, when the directivity of the corresponding quarter pixel e is determined as the horizontal direction by the directivity determiner 211, the interpolation processor 213 can predict a pixel value of the quarter pixel e through a linear interpolation method as defined in Equation 7.

e=(d+f+1)>>1 Equation 7

That is, in a case where the directivity of the quarter pixel e is determined as the horizontal direction, Equation (7) represents (d+f)/2, and the pixel value of the quarter pixel e can be predicted as a value generated by adding pixel values of pixels d and f and then dividing the added value by 2.

Further, when the directivity of the corresponding quarter pixel e is determined as the vertical direction by the directivity determiner 211, the interpolation processor 213 can predict the pixel value of the corresponding quarter pixel e according to a linear interpolation method as defined in Equation 8.

e=(a+i+1)>>1 Equation 8

That is, in a case where the directivity of the quarter pixel e is determined as the vertical direction, Equation (8) represents (a+i)/2, and the pixel value of the quarter pixel e can be predicted as a value generated by adding pixel values of pixels a and i and then dividing the added value by 2.

Moreover, when the directivity of the corresponding quarter pixel e is determined as the left diagonal direction by the directivity determiner 211, the interpolation processor 213 can predict the pixel value of the corresponding quarter pixel e according to a linear interpolation method as defined in Equation 9.

e=(b+h+1)>>1 Equation 9

That is, in a case where the directivity of the quarter pixel e is determined as the left diagonal direction, Equation (9) represents (b+h)/2, and the pixel value of the quarter pixel e can be predicted as a value generated by adding pixel values of pixels b and h and then dividing the added value by 2.

Furthermore, when the directivity of the corresponding quarter pixel e is determined as the right diagonal direction by the directivity determiner 211, the interpolation processor 213 can predict the pixel value of the corresponding quarter pixel e according to a linear interpolation method as defined in Equation 10.

e=(G++1)>>1 Equation 10

That is, in a case where the directivity of the quarter pixel e is determined as the right diagonal direction, Equation (10) represents (G+j)/2, and the pixel value of the quarter pixel e can be predicted as a value generated by adding pixel values of pixels G and j and then dividing the added value by 2.

The motion estimator 220 estimates a motion of the current frame based on the interpolated reference frame and determines a motion vector. An algorithm widely used for estimating such a motion is a block matching algorithm. That is, the displacement having the smallest error selected while a given motion block is moving in the unit of pixels within a specific searching area of the reference frame is estimated as the motion vector. A motion block having a fixed size can be used for the motion estimation, and a motion block having a variable size can be used for the motion estimation through a Hierarchical Variable Size Block Matching (HVSBM) method.

The motion estimator 220 provides data obtained through the motion estimation such as a motion vector, a motion block size, a reference frame number, etc. to an entropy encoder (not shown) and the data are encoded. Here, the motion vector may be a differential from a motion vector in a neighboring block.

The motion compensator 230 reduces the temporal redundancy of an input video frame. In this event, the motion compensator 230 generates an inter prediction frame for the current frame by performing a motion compensation for the reference frame by using the motion vector calculated by the motion estimator 220.

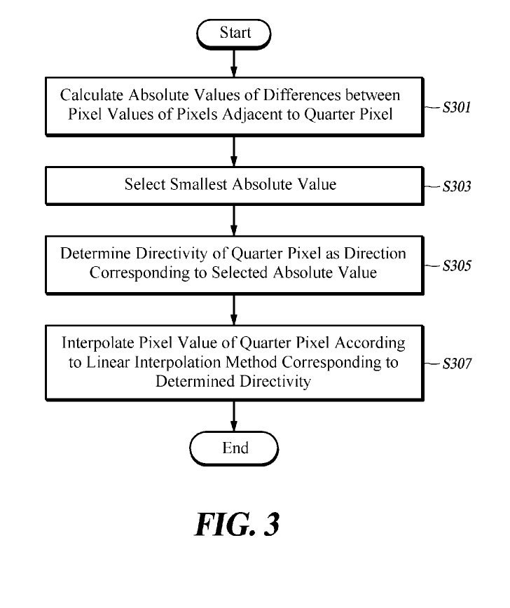

FIG. 3 is a flowchart illustrating a method of interpolating a reference frame in the unit of quarter pixels by the interpolator of FIG. 2.

Referring to FIG. 3, the interpolator 210 determines the directivity of a quarter pixel located at the intersection of a left diagonal line and a right diagonal line between half pixels based on pixels located in surroundings of the corresponding quarter pixel. To this end, the horizontal direction calculator 215 calculates an absolute value of a difference between pixel values of pixels located in left and right sides of the corresponding quarter pixel, the vertical direction calculator 216 calculates an absolute value of a difference between pixel values of pixels located in upper and lower sides of the corresponding quarter pixel, the left diagonal direction calculator 217 calculates an absolute value of a difference between pixel values of pixels located in both ends of the left diagonal line, and the right diagonal direction calculator 218 calculates an absolute value of a difference between pixel values of pixels located in both ends of the right diagonal line in step S301. For example, in a case of the quarter pixel e, the horizontal direction calculator 215, the vertical direction calculator 216, the left diagonal direction calculator 217, and the right diagonal direction calculator 218 can calculate respective absolute values as defined in Equations (3) to (6).

In this event, the directivity determiner 211 selects a calculated value having the smallest absolute value from the respective absolute values calculated by the horizontal direction calculator 215, the vertical direction calculator 216, the left diagonal direction calculator 217, and the right diagonal direction calculator 218 in step S303, and then determines the directivity of a corresponding quarter pixel as a direction corresponding to the selected absolute value in step S305. Here, although the quarter pixel e has been described as an example, such a method can be equally applied to quarter pixels g, n, and p.

The interpolation processor 213 interpolates the corresponding quarter pixel by applying the linear interpolation corresponding to the directivity of the corresponding quarter pixel determined by the directivity determiner 211 in step S307. For example, in a case of the quarter pixel e, the linear interpolation methods as defined in Equations (7) to (10) can be applied according to the directivity of the corresponding quarter pixel e by the directivity determiner 211. In this event, applied linear interpolation methods are not limited to the stated equations, and other linear interpolations can be applied.

As described above, when the pixel value of the quarter pixel is predicted, a linear interpolation method considering a pixel having the highest correlation in the relation with neighboring pixels is applied in embodiments of the present disclosure unlike the conventional method of using the same linear interpolation method in all cases, so that a more exact value can be obtained in predicting the pixel value of the quarter pixel.

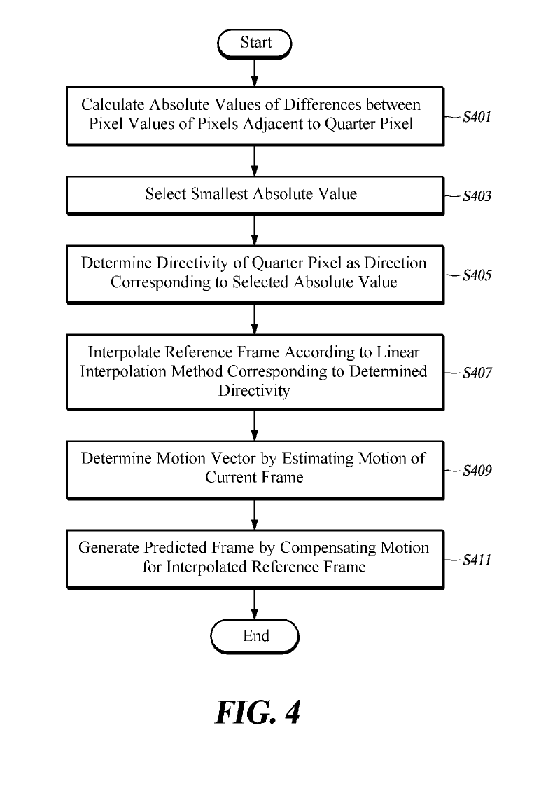

FIG. 4 is a flowchart illustrating an inter prediction frame generating method according to another embodiment of the present disclosure. Here, since steps S 401 to S405 are performed by applying the interpolation method of FIG. 3, its detailed description will be omitted.

The interpolation processor 213 interpolates the corresponding quarter pixel by applying the linear interpolation method corresponding to the directivity of the corresponding quarter pixel determined by the directivity determiner 211. In such a manner, the interpolation processor 213 interpolates the quarter pixel within the reference frame while searching for the reference frame in step S407.

The motion estimator 220 estimates a motion of the current frame based on the interpolated reference frame and determines a motion vector in step S409. Further, the motion estimator 220 provides data obtained through the motion estimation such as a motion vector, a motion block size, a reference frame number, etc. to an entropy encoder (not shown) and the data are encoded. Here, the motion vector may be a differential from a motion vector in a neighboring block.

The motion compensator 230 reduces the temporal redundancy of an input video frame. In this event, the motion compensator 230 generates an inter prediction frame for the current frame by performing a motion compensation for the reference frame by using the motion vector calculated by the motion estimator 220 in step S411.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful for application in a video apparatus using an inter prediction by interpolating pixel values of quarter pixels located at intersections of left diagonal lines and right diagonal lines in the unit of half pixels through a more exact method for a reference frame to be used for the prediction, thereby improving the inter prediction efficiency.

### CROSS-REFERENCE TO RELATED APPLICATION

If applicable, this application claims priority under 35 U.S.C §119(a) of Patent Application No. 10-2009-0117873, filed on Dec. 1, 2009 in Korea, the entire content of which is incorporated herein by reference. In addition, this non-provisional application claims priority in countries, other than the U.S., with the same reason based on the Korean Patent Application, the entire content of which is hereby incorporated by reference.

1. An apparatus for interpolating a reference frame by unit of quarter pixels, the apparatus comprising:
a directivity determiner for determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point; and
an interpolation processor for interpolating a pixel value for the quarter pixel by differently applying a linear interpolation method depending on the directivity determined by the directivity determiner.

2. The apparatus of claim 1, further comprising:
a horizontal direction calculator for calculating an absolute value of a difference between pixel values of pixels located in a left side and a right side of the quarter pixel;
a vertical direction calculator for calculating an absolute value of a difference between pixel values of pixels located in an upper side and a lower side of the quarter pixel;
a left diagonal direction calculator for calculating an absolute value of a difference between pixel values of pixels located at both ends of the left diagonal line of the quarter pixel; and
a right diagonal direction calculator for calculating an absolute value of a difference between pixel values of pixels located at both ends of the right diagonal line of the quarter pixel,
wherein the directivity determiner determines the directivity as a direction corresponding to a smallest absolute value among absolute values calculated by the horizontal direction calculator, the vertical direction calculator, the left diagonal direction calculator, and the right diagonal direction calculator.

3. The apparatus of claim 1, wherein, when the directivity for the quarter pixel is determined as a horizontal direction by the directivity determiner, the interpolation processor predicts the pixel value for the quarter pixel according to an equation of e=(d+f+1)>>1, where e is the quarter pixel, d is the pixel located in the left side of the quarter pixel, f is the pixel located in the right side of the quarter pixel, and >> is a shift operation considering a rounding off.

4. The apparatus of claim 1, wherein, when the directivity for the quarter pixel is determined as a vertical direction by the directivity determiner, the interpolation processor predicts a pixel value for the quarter pixel according to an equation of e=(a+i+1)>>1, where e is the quarter pixel, a is the pixel located in the upper side of the quarter pixel, i is the pixel located in the lower side of the quarter pixel, and >> is a shift operation considering a rounding off.

5. The apparatus of claim 1, wherein, when the directivity for the quarter pixel is determined as a right diagonal direction by the directivity determiner, the interpolation processor predicts a pixel value for the quarter pixel according to an equation of e=(G+j+1)>>1, where e is the quarter pixel, G is the pixel located in a left upper side of the quarter pixel, j is the pixel located in a right lower side of the quarter pixel, and >> is a shift operation considering a rounding off.

6. The apparatus of claim 1, wherein, when the directivity for the quarter pixel is determined as a left diagonal direction by the directivity determiner, the interpolation processor predicts a pixel value for the quarter pixel according to an equation of e=(b+h+1)>>1, where e is the quarter pixel, b is the pixel located in a right upper side of the quarter pixel, h is the pixel located in a left lower side of the quarter pixel, and >> is a shift operation considering a rounding off.

7. An apparatus for generating an inter prediction frame, the apparatus comprising:
an interpolator for determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point and interpolating a reference frame by differently applying a linear interpolation method according to determined directivity;
a motion estimator for estimating a motion of a current frame based on an interpolated reference frame and determining a motion vector; and
a motion compensator for performing a motion compensation on the interpolated reference frame by using the motion vector determined by the motion estimator.

8. A method for interpolating a reference frame by unit of quarter pixels, the method comprising:
determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point; and
interpolating a pixel value for the quarter pixel by differently applying a linear interpolation method according to the directivity determined in determining of the directivity.

9. The method of claim 8, wherein determining of the directivity comprises:
calculating an absolute value of a difference between pixel values of pixels located in a left side and a right side of the quarter pixel, an absolute value of a difference between pixel values of pixels located in an upper side and a lower side of the quarter pixel, an absolute value of a difference between pixel values of pixels located at both ends of the left diagonal line of the quarter pixel, and an absolute value of a difference between pixel values of pixels located at both ends of the right diagonal line of the quarter pixel; and
selecting a smallest absolute value by comparing between respective calculated absolute values,
wherein the directivity is determined as a direction corresponding to a selected absolute value.

10. A method for generating an inter prediction frame, the method comprising: determining directivity of a quarter pixel located at the intersection of a left diagonal line and a right diagonal line of a half-pixel unit based on pixel values of pixels located in up and down directions, left and right directions, opposite directions of the left diagonal line, and opposite directions of the right diagonal line with the quarter pixel as a reference point;
interpolating a reference frame by differently applying a linear interpolation method depending on the directivity determined in determining of the directivity;
estimating a motion of a current frame based on an interpolated reference frame and determining a motion vector; and
generating a predicted frame for the current frame by performing a motion compensation on the interpolated reference frame by using the motion vector determined in estimating of the motion.

11. A non-transitory computer readable recording medium storing a computer program including computer-executable instructions for causing, when executed in a processor, the processor to perform the method for interpolating the reference frame of claim 8.

12. The apparatus of claim 2, wherein, when the directivity for the quarter pixel is determined as a horizontal direction by the directivity determiner, the interpolation processor predicts the pixel value for the quarter pixel according to an equation of e=(d+f+1)>>1, where e is the quarter pixel, d is the pixel located in the left side of the quarter pixel, f is the pixel located in the right side of the quarter pixel, and >> is a shift operation considering a rounding off.

13. The apparatus of claim 2, wherein, when the directivity for the quarter pixel is determined as a vertical direction by the directivity determiner, the interpolation processor predicts a pixel value for the quarter pixel according to an equation of e=(a+i+1)>>1, where e is the quarter pixel, a is the pixel located in the upper side of the quarter pixel, i is the pixel located in the lower side of the quarter pixel, and >> is a shift operation considering a rounding off.

14. The apparatus of claim 2, wherein, when the directivity for the quarter pixel is determined as a right diagonal direction by the directivity determiner, the interpolation processor predicts a pixel value for the quarter pixel according to an equation of e=(G+j+1)>>1, where e is the quarter pixel, G is the pixel located in a left upper side of the quarter pixel, j is the pixel located in a right lower side of the quarter pixel, and >> is a shift operation considering a rounding off.

15. The apparatus of claim 2, wherein, when the directivity for the quarter pixel is determined as a left diagonal direction by the directivity determiner, the interpolation processor predicts a pixel value for the quarter pixel according to an equation of e=(b+h+1)>>1, where e is the quarter pixel, b is the pixel located in a right upper side of the quarter pixel, h is the pixel located in a left lower side of the quarter pixel, and >> is a shift operation considering a rounding off.

16. A non-transitory computer readable recording medium storing a computer program including computer-executable instructions for causing, when executed in a processor, the processor to perform the method for interpolating the reference frame of claim 9.
